(19) United States
(12) Patent Application Publication
(10) Pub. No.: US 2018/0046936 A1
(43) Pub. Date: Feb. 15, 2018

(54) DENSITY-BASED APPARATUS, COMPUTER PROGRAM, AND METHOD FOR RECLASSIFYING TEST DATA POINTS AS NOT BEING AN ANOMOLY

(71) Applicant: Futurewei Technologies, Inc., Plano, TX (US)

(72) Inventors: Zhibi Wang, Woodridge, IL (US); Shuang Zhou, Chicago, IL (US)

(21) Appl. No.: 15/233,852

(22) Filed: Aug. 10, 2016

(51) Int. Cl. G06N 99/00

(52) U.S. Cl. CPC G06N 99/005

(57) ABSTRACT

An density-based apparatus, computer program, and method are provided for reclassifying test data points as not being an anomaly. One or more test data points are received that are each classified as an anomaly. In connection with each of the one or more test data points, a density is determined for a plurality of known data points that are each known to not be an anomaly. Further, at least one of the one or more test data points is reclassified as not being an anomaly, based on the determination.

### FIELD OF THE INVENTION

The present invention relates to anomaly detection, and more particularly to techniques for reducing false positives in connection with anomaly detection.

### BACKGROUND

In the area of machine learning, algorithms are constructed that can learn from existing data and make predictions. As one example, cluster analysis is typically used as an algorithm to detect an anomaly by grouping test data items based on characteristics so that different groups contain objects with dissimilar characteristics. Good clustering is characterized by high similarity within a group, and high differences among different groups.

In use, a set of test data items may contain a subset whose characteristics are significantly different from the rest of the test data items. This subset of test data items are each known as an anomaly (e.g. outlier, etc.). Anomaly identification thus produces smaller groups of test data items that are considerably different from the rest. Such technique has applications in fields including, but not limited to detecting advanced persistent threat (APT) attacks in telecommunication systems, financial fraud detection, rare gene identification, data cleaning, etc.

One popular example of a non-parametric anomaly identification technique that has been extensively employed involves the use of a one-class support vector machine (OCSVM). OCSVM exhibits efficiency in computation, however, it typically does not utilize distribution properties of a dataset, and further has no direct control over a false positive rate (FPR).

### SUMMARY

An density-based apparatus, computer program, and method are provided for reclassifying test data points as not being an anomaly. One or more test data points are received that are each classified as an anomaly. In connection with each of the one or more test data points, a density is determined for a plurality of known data points that are each known to not be an anomaly. Further, at least one of the one or more test data points is reclassified as not being an anomaly, based on the determination.

In a first embodiment, the one or more test data points may each be classified as an anomaly, by a one-class support vector machine (OCSVM), and/or a K-means clustering algorithm. For example, the one or more test data points may each be classified as an anomaly, by: grouping a plurality of the test data points into a plurality of groups based on one or more parameters, identifying at least one frontier for each group of the plurality of the test data points, determining whether the one or more test data points are outside of a corresponding frontier, and classifying the one or more test data points as an anomaly if the one or more test data points are outside of the corresponding frontier.

In a second embodiment (which may or may not be combined with the first embodiment), the one or more test data points may include a plurality of the test data points. Further, the determination of the density may be performed for each of the plurality of the test data points. Still yet, the determination of the density may result in density information corresponding with each of the plurality of the test data points. Thus, the plurality of the test data points may be ranked, based on the density information. Further, resources may be allocated, based on the ranking.

In a third embodiment (which may or may not be combined with the first and/or second embodiments), the reclassification of the one or more test data points as not being an anomaly, may result in a reduction of false positives.

In a fourth embodiment (which may or may not be combined with the first, second, and/or third embodiments), the one or more test data points may reflect security event occurrences. In other aspects of the present embodiment, the one or more test data points may reflect other types of occurrences or anything else, for that matter.

To this end, in some optional embodiments, one or more of the foregoing features of the aforementioned apparatus, computer program, and/or method may reduce false positives, by reducing test data points classified as anomalies using a density-based approach. This may, in turn, result in a reduction and/or reallocation of resources required for processing test data points that are classified as anomalies when, in fact, they are not. It should be noted that the aforementioned potential advantages are set forth for illustrative purposes only and should not be construed as limiting in any manner.

### BRIEF DESCRIPTION OF THE DRAWINGS

FIG. 1 illustrates a method for reclassifying test data points as not being an anomaly, in accordance with one embodiment.

FIG. 2 illustrates a system for reclassifying test data points as not being an anomaly and ranking the same, in accordance with one embodiment.

FIG. 3 illustrates a method for performing clustering-based anomaly detection, in accordance with one embodiment.

FIG. 4A illustrates a method for performing density-based anomaly detection, in accordance with one embodiment.

FIG. 4B illustrates a method for performing clustering-based anomaly detection, in accordance with a threat assessment embodiment.

FIG. 4C illustrates a method for performing density-based anomaly detection, in accordance with a threat assessment embodiment.

FIG. 4D illustrates a system for reclassifying test data points as not being an anomaly and ranking the same, in accordance with one embodiment.

FIG. 5 illustrates a plot showing results of a clustering-based anomaly detection method that may be subject to a density-based anomaly detection for possible reclassification of anomalies as being normal, in accordance with one embodiment.

FIG. 6 illustrates a network architecture, in accordance with one possible embodiment.

FIG. 7 illustrates an exemplary system, in accordance with one embodiment.

### DETAILED DESCRIPTION

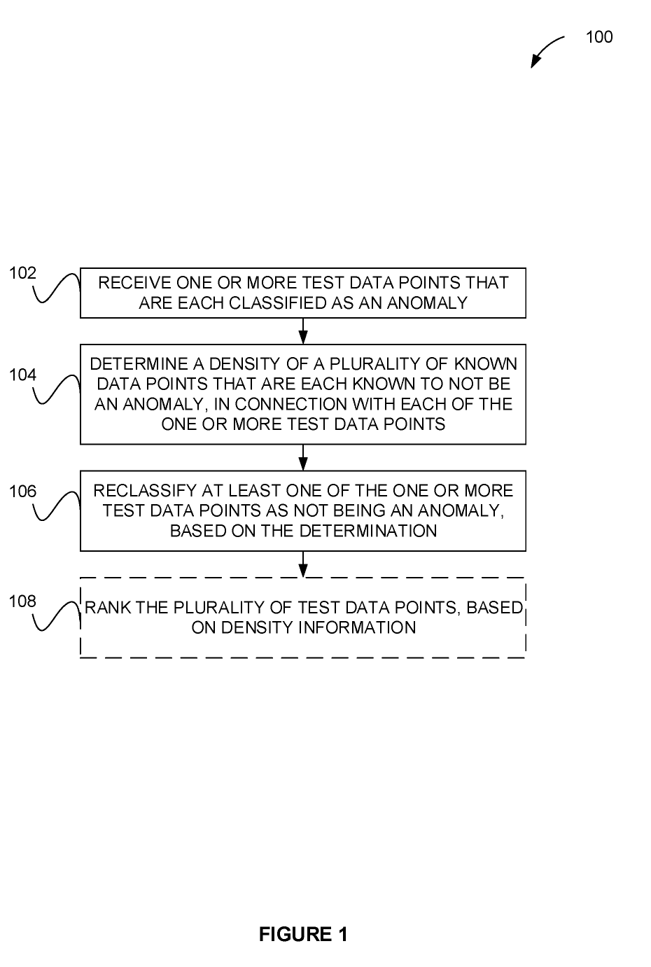

FIG. 1 illustrates a method 100 for reclassifying test data points as not being an anomaly, in accordance with one embodiment. As shown, one or more test data points are received that are each classified as an anomaly. See operation 102. In the context of the present description, a test data point may refer to any data structure that includes information on a person, place, thing, occurrence, and/or anything else that is capable of being classified as an anomaly. Still yet, such anomaly may refer to anything thing that deviates from what is standard, normal, and/or expected. In various embodiments, parameters, thresholds, etc. that are used (if at all) to define an anomaly may vary in any desired manner.

For example, in one embodiment, the one or more test data points may reflect security event occurrences in the context of an information security system. Specifically, in such embodiment, the one or more test data points may be gathered in the context of an intrusion detection system (IDS), intrusion prevention system (IPS), firewall, security incident and event management (STEM) system, and/or any other type of security system that is adapted for addressing advanced persistent threat (APT), zero-day, and/or unknown attacks (i.e. for which signatures/fingerprints are not available, etc.). It should be strongly noted, however, that the one or more test data points may reflect other types of occurrences. For instance, such anomaly detection may be applied to financial fraud detection, rate gene identification, data cleaning, and/or any other application that may benefit from anomaly detection.

Also, in the present description, the aforementioned classification may be accomplished utilizing absolutely any technique operable for classifying test data points as anomalies. For example, in one possible embodiment, the one or more test data points may be each classified as an anomaly, utilizing a clustering-based technique (or any other technique, for that matter). One example of such a clustering-based techniques may involve usage of a K-means clustering algorithm. In one embodiment, such K-means clustering algorithm may involve any algorithm that partitions n observations into k clusters where each observation belongs to the cluster with the nearest mean.

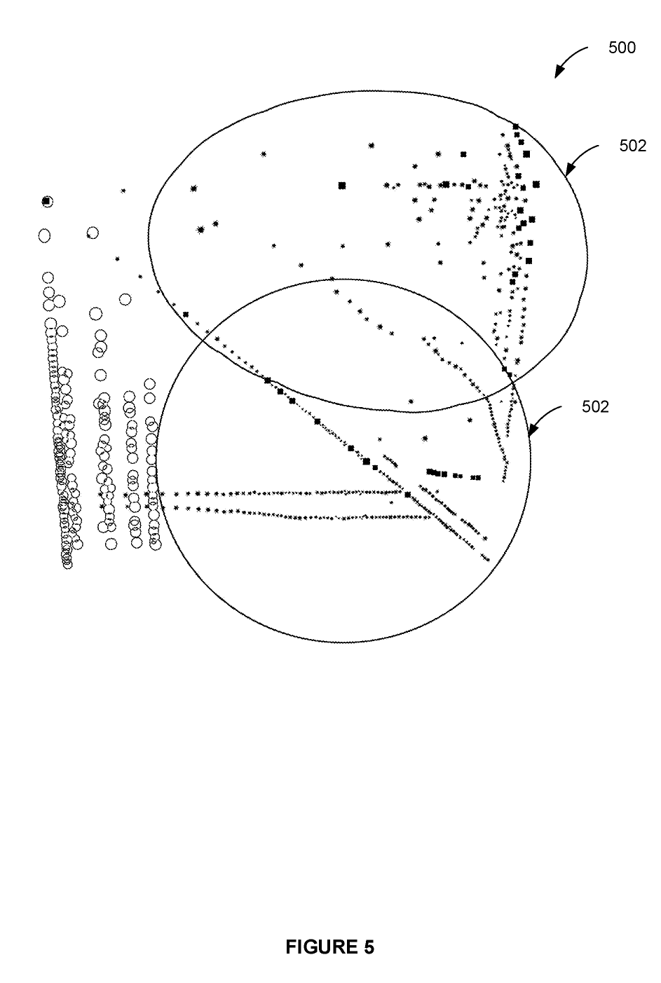

Another example of such an anomaly detection technique may involve usage of a one-class support vector machine (OCSVM) on each cluster after clustering. Specifically, in one optional embodiment, the one or more test data points may each be classified as an anomaly, by: grouping a plurality of the test data points into a plurality of groups based on one or more parameters, identifying at least one frontier for each group of the plurality of the test data points, determining whether the one or more test data points are outside of a corresponding frontier, and classifying the one or more test data points as an anomaly if the one or more test data points are outside of the corresponding frontier. In the context of the present description, the aforementioned frontier may refer to any boundary or any other parameter defining the grouping of known data points, where such frontier may be used to classify each test data point. An example of such a frontier will be set forth later during the description of FIG. 5. More information regarding such possible embodiment will be described later during the description of subsequent embodiments.

With continuing reference to FIG. 1, the method 100 continues in connection with each of the one or more test data points, by determining a density for a plurality of known data points that are each known to not be an anomaly. See operation 104. In different embodiments, the known data points may be designated as such via any desired analysis and/or result including, but not limited to an empirical analysis, inference, assumption, etc. Further, it should be noted that the one or more test data points may include a plurality of the test data points, such that the determination of the density may be performed for each of the plurality of the test data points.

Still yet, in the context of the present description, the density may refer to any quantity per unit of a limited extent that may be measured in one, two, and/or multiple-dimensions. For instance, in one embodiment where the known data points are plotted on a two-dimensional graph (with x, y axes reflecting any desired parameters), the density may refer to a quantity per unit of space (e.g. area, length, etc.). Still yet, the exact location of the aforementioned “limited extent” (as compared to each test data point), as well as the metes and bounds (e.g. area, etc.) thereof, may be statically and/or dynamically defined in any desire manner.

As indicated in operation 106, at least one of the one or more test data points is reclassified as not being an anomaly, based on the determination of operation 104. In the context of the present description, such reclassification may refer to any change in the test data point(s) and/or information associated therewith that indicates and/or may be used to indicate that the test data point(s) is not an anomaly. In use, it is contemplated that some reclassification attempts may result in no reclassification.

Strictly as an option, operation 108 (shown in phantom) may be performed. Specifically, the determination of the density (per operation 104) may result in density information corresponding with each of the plurality of the test data points. Based on this density information, the plurality of the test data points may be ranked per operation 108. In one possible embodiment, any one or more of the operations 104-108 may be performed utilizing a processor (examples of which will be set forth later) that may or may not be in communication with the aforementioned interface, such that a result thereof may be output via at least one output device (examples of which will be set forth later) that may or may not be in communication with the processor.

As yet another option, resources may be allocated, based on the ranking. In the context of the present description, the aforementioned resources may include any automated hardware/software/service and/or manual procedure. Further, the resources may, in one embodiment, be allocated to an underlying occurrence (or anything else) that prompted the relevant test data points that are anomalies.

To this end, in some optional embodiments, one or more of the foregoing features may reduce false positives, by reducing test data points classified as anomalies using a density-based approach. For example, the reclassification of the at least one test data point as not being an anomaly, may result in such reduction of false positives. As mentioned earlier, OCSVM, for example, exhibits efficiency in computation, however, it typically does not utilize distribution properties of a dataset. Thus, as will be described later, error rate is improved via a density-based approach in connection with the OCSVM, by virtue of the use of a different technique that is based on different anomaly-detection criteria (e.g. density-related criteria). As further elaborated upon later, the purpose of such density-based processing is to confirm, with greater certainty by using a non-clustering-based anomaly detection technique, whether the test data points are likely to be actual anomalies, as originally classified. This may, in turn, result in a reduction and/or allow a reallocation of resources required for processing test data points that are classified as an anomaly when, in fact, they are not. It should be noted that the aforementioned potential advantages are set forth for illustrative purposes only and should not be construed as limiting in any manner.

More illustrative information will now be set forth regarding various optional architectures and uses in which the foregoing method may or may not be implemented, per the desires of the user. It should be noted that the following information is set forth for illustrative purposes and should not be construed as limiting in any manner. Any of the following features may be optionally incorporated with or without the exclusion of other features described.

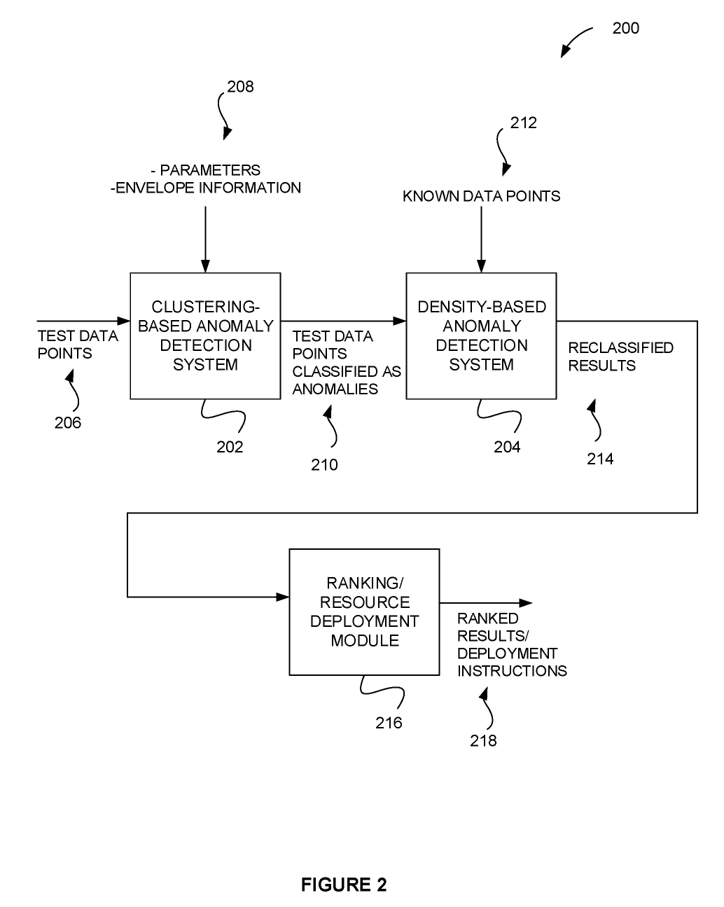

FIG. 2 illustrates a system 200 for reclassifying test data points as not being an anomaly and ranking the same, in accordance with one embodiment. As an option, the system 200 may be implemented with one or more features of any one or more of the embodiments set forth in any previous and/or subsequent figure(s) and/or the description thereof. However, it is to be appreciated that the system 200 may be implemented in the context of any desired environment.

As shown, a clustering-based anomaly detection system 202 is provided that receives test data points 206, along with a variety of information 208 for use in classifying the test data points 206 as anomalies based on a clustering technique. In use, a clustering-based analysis may be used as an unsupervised algorithm to detect anomalies, which groups data objects based on characteristics so that different groups contain objects with dissimilar characteristics. Such clustering may be characterized by high similarity within a group and high differences among different groups.

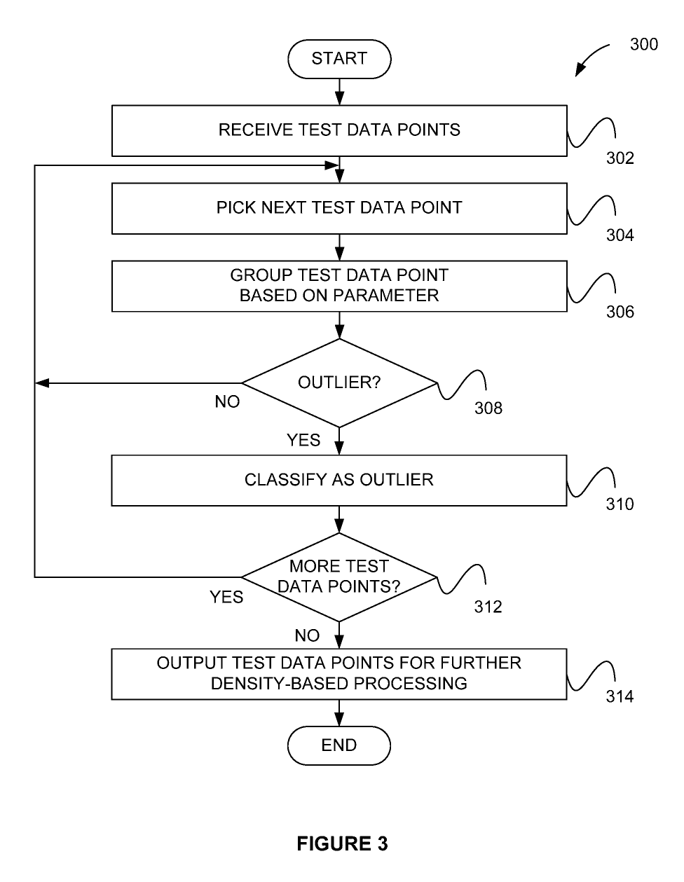

In one embodiment, the clustering-based anomaly detection system 202 may include a OCSVM that requires the information 208 in the form of a plurality of parameters and learning frontier information. Specifically, the learning frontier information may be defined by known data points that are known to be normal, etc. Using such input, the clustering-based anomaly detection system 202 serves to determine whether the test data points 206 reside outside such learning frontier and, if so, classify such outlying test data points 206 as anomalies 210. More information regarding an exemplary method for performing a clustering-based analysis will be set forth in greater detail during reference to FIG. 3.

With continuing reference to FIG. 2, further provided is a density-based anomaly detection system 204 that is in communication with the clustering-based anomaly detection system 202. While shown to be discrete components (that may or may not be remotely positioned), it should be noted that the clustering-based anomaly detection system 202 and the density-based anomaly detection system 204 may be integrated in a single system. As further shown, the density-based anomaly detection system 204 may receive, as input, the anomalies 210 outputted from the clustering-based anomaly detection system 202. Further, known data points 212 may be further input into the density-based anomaly detection system 204 for performing a density-based analysis (different from the foregoing clustering-based technique) to confirm whether the anomalies 210 have each been, in fact, properly classified as being an anomaly.

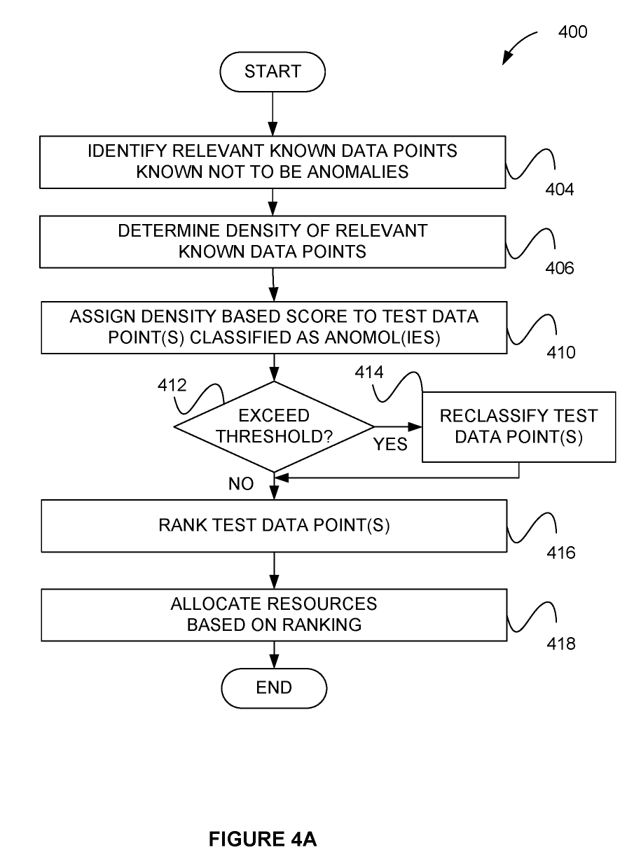

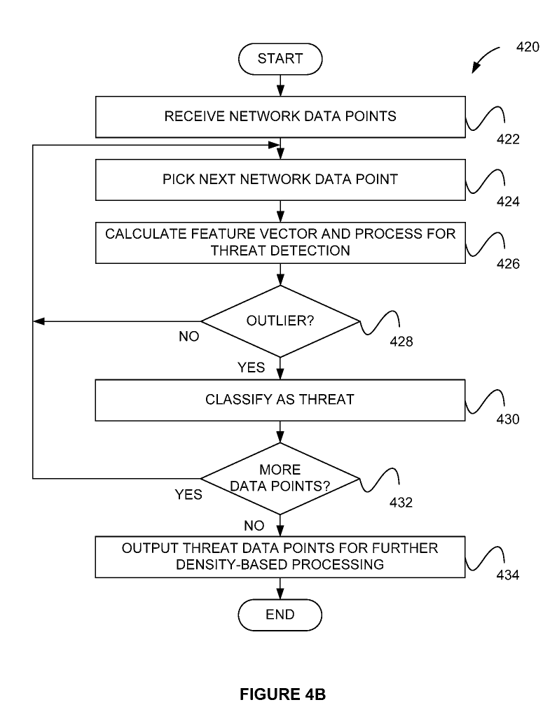

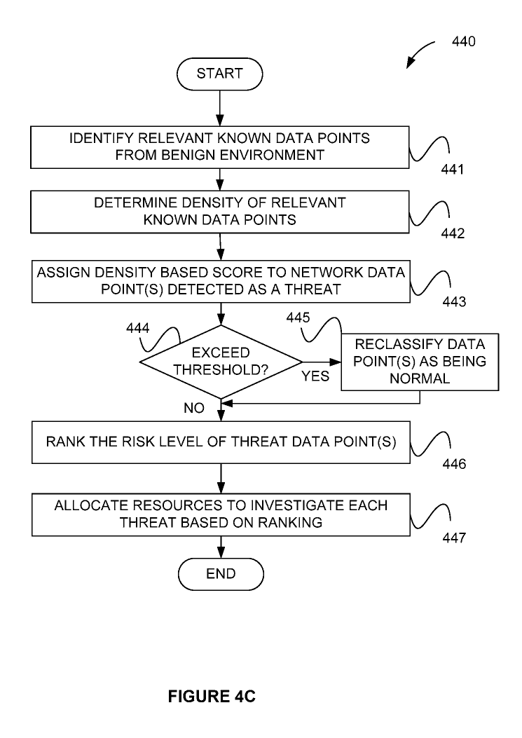

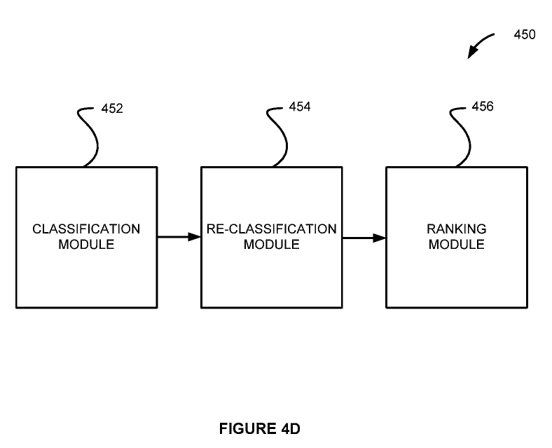

Specifically, for each of the anomalies 210, at least one relevant group of the known data points 212 (that are known to be normal, i.e. not anomalies) are processed to identify a density of such known data points 212. If the density of the known data points 212 in connection with one of the anomalies 210 is low (e.g. below a certain threshold, etc.), it may be determined that the original classification of such anomaly properly classified the same as an anomaly and no reclassification need take place. On the other hand, if the density of the known data points 212 in connection with one of the anomalies 210 is high (e.g. above a certain threshold, etc.), it may be determined that the original classification of such anomaly did not properly classify the same as an anomaly and reclassification may take place, so as to produce one or more reclassified results 214. For reasons that will soon become apparent, a score that indicates or is otherwise based on the aforementioned density analysis, may be included with the one or more reclassified results 214. More information regarding an exemplary method for performing a density-based analysis will be set forth in greater detail during reference to FIG. 4A.

Further provided is an optional ranking/resource deployment module 216 that is in communication with the density-based anomaly detection system 204. In operation, the ranking/resource deployment module 216 uses the scores of the reclassified results 214 to rank the same. Specifically, such ranking may, in one embodiment, place the reclassified results 214 with a lower density score (that are thus more likely to be an anomaly) higher on a ranked list, while the reclassified results 214 with a higher density score (that are thus more likely to not be an anomaly, e.g. normal) lower on the ranked list.

To this end, the aforementioned ranked list is output from the ranking/resource deployment module 216, as ranked results 218. In one embodiment, such ranked results 218 may also be used to deploy resources to address the underlying occurrence (or anything else) that is represented by the ranked results 218. Further, at least one aspect of such resource deployment may be based on a ranking of the corresponding ranked results 218. For example, in one embodiment, the ranked results 218 that are higher ranked may be addressed first, before the ranked results 218 that are lower ranked. In another embodiment, the ranked results 218 that are higher ranked may be allocated more resources, while the ranked results 218 that are lower ranked may be allocated less resources.

In one embodiment, the aforementioned resources may include manual labor that is allocated through an automated or manual ticketing process for allocating/tracking the same. In other embodiments, the aforementioned resources may include software agents deployable under the control of a system with finite resources. Of course, the resources may refer to anything that is configured to resolve one or more issues surrounding an anomaly.

FIG. 3 illustrates a method 300 for performing clustering-based anomaly detection, in accordance with one embodiment. As an option, the method 300 may be implemented in the context of any one or more of the embodiments set forth in any previous and/or subsequent figure(s) and/or description thereof. For example, in one embodiment, the method 300 may be implemented in the context of the clustering-based anomaly detection system 202 of FIG. 2. However, it is to be appreciated that the method 300 may be implemented in the context of any desired environment.

As shown, test data points are received in operation 302. Such receipt may be achieved in any desired manner. For instance, the test points may be uploaded into a clustering-based anomaly detection system (e.g. the clustering-based anomaly detection system 202 of FIG. 2, etc.). Upon receipt, each test data point is processed one-by-one, as shown.

Specifically, in operation 304, an initial/next test data point is picked, and such test data point is grouped based on one or more parameters. See operation 306. Specifically, a particular cluster may be selected that represents a range of parameter values that best fits the current test data point picked in operation 304. Such parameters may reflect any aspect of the underlying entity that is being classified. Just by way of example, in the context of packets intercepted over a network, such parameters may include one or more of an Internet Protocol (IP) address, a port, a packet type, time stamp, fragmentation, etc.

It is then determined in decision 308 whether the current test data point picked in operation 304 resides outside (i.e. outlies, etc.) the cluster that is determined in operation 306. If not, the current test data point is determined not to be an anomaly and the method 300 continues by picking the next test data point in operation 304. On the other hand, if the current test data point picked in operation 304 resides outside (i.e. outlies, etc.) the cluster that is determined in operation 306, such current test data point is classified as an outlier (e.g. anomaly, etc.). See operation 310.

Per decision 312, the method 300 continues with operations 304-312 for each test data point until complete. At such time, the test data points (that are classified as anomalies) are output in operation 314, for further density-based processing to confirm, with greater certainty and using a non-clustering-based anomaly detection technique, whether the test data points are likely to be actual anomalies, as originally classified. More information regarding one possible density-based anomaly detection technique will now be set forth.

FIG. 4A illustrates a method 400 for performing density-based anomaly detection, in accordance with one embodiment. As an option, the method 400 may be implemented in the context of any one or more of the embodiments set forth in any previous and/or subsequent figure(s) and/or description thereof. For example, in one embodiment, the method 400 may be implemented in the context of the density-based anomaly detection system 204 and/or ranking/resource deployment module 216 of FIG. 2. However, it is to be appreciated that the method 400 may be implemented in the context of any desired environment. In one embodiment, the method 400 illustrated in FIG. 4A may be a continuation of the method illustrated in FIG. 3. One advantage of a method that includes some or all of the steps of FIGS. 3 and 4A is that a number of false positives may be reduced.

As shown, relevant known data points known to not be anomalies are identified in operation 404. The relevancy of such known data points may be based on any desired factors. For example, the known data points that are relevant may be those that are in close proximity to test data points to be analyzed, that are within a predetermined or configurable space (dependent or independent of the test data points to be analyzed), and/or those that are deemed relevant based on other criteria.

In operation 406, the density of the relevant known data points are determined. As mentioned earlier, this may, in one embodiment, involve a calculation of a number of the known data points in a certain area. Further, a density-based score is assigned to each of the test data points classified as anomalies. See operation 410. In one embodiment, such density-based score may be linearly or otherwise proportional to the aforementioned density. Further, each test data point (or small group of the same) may be assigned a corresponding density-based score.

Next, in decision 412, it is determined, for each test data point, whether the density-based score exceeds a threshold. Such threshold may be statically or dynamically determined for the purpose of reclassifying the test data point(s) (as not being an anomaly, e.g. normal, etc.). See operation 414. For example, in various embodiments, the threshold may be configurable (e.g. user-/system-configurable, etc.).

Next, in operation 416, the test data points are ranked, based on the density-based score. In one embodiment, only those test data points that are not reclassified may be ranked. Of course, in other embodiments, all of the test data points may be ranked. To this end, resources may be allocated in operation 418, based on the ranking, so that those test data points that are more likely to be anomalies are allocated resources preferentially over those that are less likely to be anomalies. By this design, resources are more intelligently allocated so that expending such resources on test data points (that are less likely to be anomalies) may be at least partially avoided. Such saved resources may, in turn, be optionally re-allocated, as desired.

FIG. 4B illustrates a method 420 for performing clustering-based anomaly detection, in accordance with a threat assessment embodiment. As an option, the method 420 may be implemented in the context of any one or more of the embodiments set forth in any previous and/or subsequent figure(s) and/or description thereof. For example, in one embodiment, the method 420 may be implemented in the context of the clustering-based anomaly detection system 202 of FIG. 2. However, it is to be appreciated that the method 420 may be implemented in the context of any desired environment.

As shown, network data points are received in operation 422. In various embodiments, the network data points may include any network data (e.g. source/destination information, session information, header/payload information, etc.). Further, such receipt may be achieved in any desired manner. For instance, the test points may be uploaded into a clustering-based anomaly detection system (e.g. the clustering-based anomaly detection system 202 of FIG. 2, etc.). Upon receipt, each network data point is processed one-by-one, as shown.

Specifically, in operation 424, an initial/next network data point is picked, and a feature vector is calculated to be processed for threat detection. See operation 426. Specifically, the feature vector may be representative of any one or more parameters associated with the network data point. Further, such feature vector may be used to select a particular cluster that corresponds best with the current network data point picked in operation 424. As mentioned earlier, in the context of packets intercepted over a network, the aforementioned parameters may include one or more of an Internet Protocol (IP) address, a port, a packet type, time stamp, fragmentation, etc.

It is then determined in decision 428 whether the current network data point picked in operation 424 resides outside (i.e. outlies, etc.) the selected cluster. If not, the current network data point is determined not to be a threat and the method 420 continues by picking the next network data point in operation 424. On the other hand, if the current network data point picked in operation 424 resides outside (i.e. outlies, etc.) the selected cluster, such current network data point is classified as an anomaly (e.g. a threat, etc.) per operation 430.

Per decision 432, the method 420 continues with operations 424-430 for each network data point until complete. At such time, the network data points (that are classified as threats) are output in operation 434, for further density-based processing to confirm, with greater certainty and using a non-clustering-based anomaly detection technique, whether the network data points are likely to be actual threats, as originally classified. More information regarding one possible density-based anomaly detection technique will now be set forth in the context of a threat assessment embodiment.

FIG. 4C illustrates a method 440 for performing density-based anomaly detection, in accordance with a threat assessment embodiment. As an option, the method 440 may be implemented in the context of any one or more of the embodiments set forth in any previous and/or subsequent figure(s) and/or description thereof. For example, in one embodiment, the method 440 may be implemented in the context of the density-based anomaly detection system 204 and/or ranking/resource deployment module 216 of FIG. 2. However, it is to be appreciated that the method 440 may be implemented in the context of any desired environment. In one embodiment, the method illustrated in FIG. 4C may be a continuation of the method illustrated in FIG. 4B.

As shown, relevant data points known to not be anomalies (e.g. threats, etc.) are identified in operation 441. The relevancy of such known data points may be based on any desired factors. For example, the known data points that are relevant may be those that are in close proximity to network data points to be analyzed, those that are within a predetermined or configurable space (dependent or independent of the network data points to be analyzed), and/or those that are deemed relevant based on other criteria. In one possible embodiment, the known data points may be gathered from a benign environment where it is known that there are no threats.

In operation 442, the density of the relevant known data points are determined. As mentioned earlier, this may, in one embodiment, involve a calculation of a number of the known data points in a certain area. Further, a density-based score is assigned to each of the network data points classified as a threat. See operation 443. In one embodiment, such density-based score may be linearly or otherwise proportional to the aforementioned density. Further, each network data point (or small group of the same) may be assigned a corresponding density-based score.

Next, in decision 444, it is determined, for each network data point, whether the density-based score exceeds a threshold. Such threshold may be statically or dynamically determined for the purpose of reclassifying the network data point(s) (as not being a threat, e.g. normal, etc.). See operation 445.

Next, in operation 446, the network data points are ranked, based on the density-based score. In one embodiment, only those network data points that are not reclassified may be ranked. Of course, in other embodiments, all of the network data points may be ranked. In any case, the ranking may reflect a risk level of the relative data points.

In one embodiment, a threshold value of 0.05 may be used in the context of the decision 444. Since the density-based technique of the method 440 and, in particular operation 446, calculates the risk level of each network point against nominal data points, the threshold may be viewed as a significance level [i.e. false positive rate (FPR), etc.]. In other words, by setting such threshold, one may ensure that the resulting FPR is no larger than the threshold value. This may afford a possible advantage over OCSVM, since the latter typically has no control over FPR. In fact, under certain assumptions over the anomaly distribution, the density-based method 440 may constitute a uniformly most powerful (UMP) test. That is to say that one may achieve a FPR no larger than the threshold value, while maintaining a highest recall rate. In one possible embodiment, the aforementioned FPR may be significantly improved (e.g. from 0.0132 to 0.0125, etc.) depending on the specific particular scenario.

To this end, resources may be allocated, based on the ranking in operation 447, so that those network data points that are more likely to be threats are allocated resources preferentially over those that are less likely to be threats. By this design, resources are more intelligently allocated so that expending such resources on network data points (that are less likely to be threats) may be at least partially avoided. Such saved resources may, in turn, be optionally re-allocated, as desired.

FIG. 4D illustrates a system 450 for reclassifying test data points as not being an anomaly and ranking the same, in accordance with one embodiment. As an option, the system 450 may be implemented with one or more features of any one or more of the embodiments set forth in any previous and/or subsequent figure(s) and/or the description thereof. However, it is to be appreciated that the system 450 may be implemented in the context of any desired environment.

As shown, a classification means in the form of a classification module 452 is provided for classifying one or more test data points. In various embodiments, the classification module 452 may include, but is not limited to the clustering-based anomaly detection system 202 of FIG. 2, at least one processor (to be described later) and any software controlling the same, and/or any other circuitry capable of the aforementioned functionality.

Also included is a re-classification means in the form of a re-classification module 454 in communication with the classification module 452 for determining a density of a plurality of known data points that are each known to not be an anomaly, and reclassifying at least one of the one or more test data points as not being an anomaly, based on the determination. In various embodiments, the re-classification module 454 may include, but is not limited to the density-based anomaly detection system 204 of FIG. 2, at least one processor (to be described later) and any software controlling the same, and/or any other circuitry capable of the aforementioned functionality.

With continuing reference to FIG. 4D, ranking means in the form of a ranking module 456 is in communication with the re-classification module 454 for ranking the plurality of the test data points, based on density information corresponding with each of the plurality of the test data points. In various embodiments, the ranking module 456 may include, but is not limited to the ranking/resource deployment module 216 of FIG. 2, at least one processor (to be described later) and any software controlling the same, and/or any other circuitry capable of the aforementioned functionality.

FIG. 5 illustrates a plot 500 showing results of a clustering-based anomaly detection method that may be subject to a density-based anomaly detection for possible reclassification of anomalies as being normal, in accordance with one embodiment. As an option, the plot 500 may be reflect operation of any one or more of the embodiments set forth in any previous and/or subsequent figure(s) and/or description thereof. For example, in one embodiment, the plot 500 may be reflect operation of the system 200 of FIG. 2.

As shown, the plot 500 includes learned frontiers in the form of a pair of frontiers 502 that are used in connection with a cluster-based anomaly detection technique (e.g. the method 300 of FIG. 3, etc.). Specifically, a plurality of test data points (designated as “□” and “∘”) are shown to be both inside and outside of the frontiers 502, as a result of the cluster-based anomaly detection technique. It should be noted that some of the test data points (designated as “□”) are those that are deemed normal, and some of the test data points (designated as “∘”) are those that are deemed as being an anomaly (e.g. abnormal, etc.).

In use, it is the normal test data points (□) that are outside the frontiers 502 (and thus are classified as an anomaly) that are the subject of a density-based anomaly detection technique (e.g. the method 400 of FIG. 4A, etc.). Such density-based anomaly detection technique involves a plurality of known data points (designated as “¤”) and, in particular, a calculation of a density of such known data points (“¤”) proximate to the test data points (□). By this design, the test data points (□), that would otherwise be classified as an anomaly based on the cluster-based anomaly detection technique, are reclassified as not being an anomaly (and possibly ranked), thereby reducing false positives.

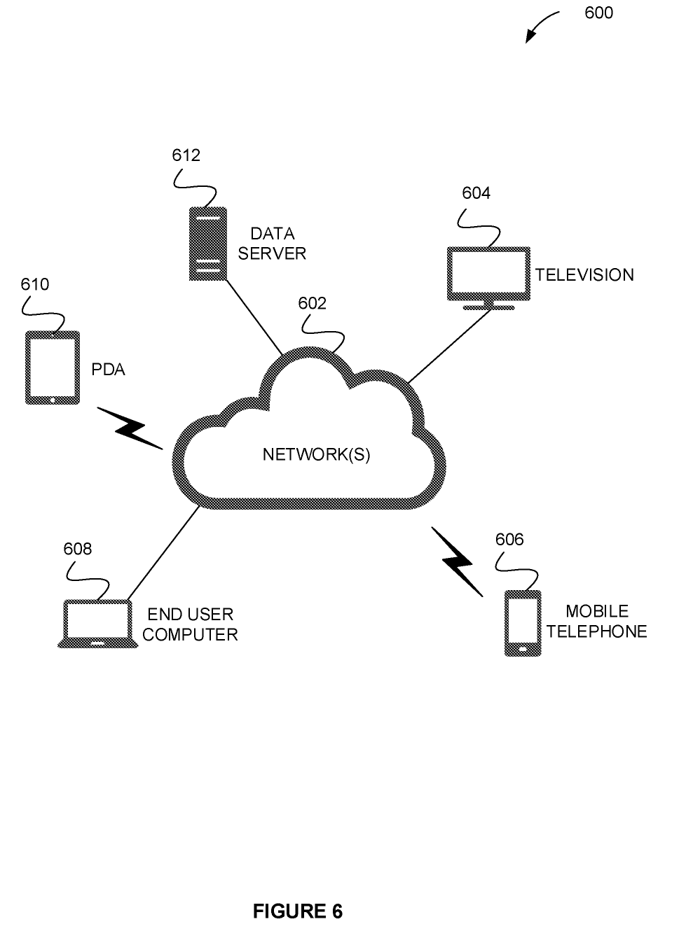

FIG. 6 illustrates a network architecture 600, in accordance with one embodiment. In various embodiments, the network architecture 600 (or any component thereof) may incorporate any one or more features of any one or more of the embodiments set forth in any previous figure(s) and/or description thereof. Further, in other embodiments, the network architecture 600 may itself be the subject of anomaly detection provided by any one or more of the embodiments set forth in any previous figure(s) and/or description thereof.

As shown, at least one network 602 is provided. In the context of the present network architecture 600, the network 602 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 602 may be provided.

Coupled to the network 602 is a plurality of devices. For example, a server computer 612 and an end user computer 608 may be coupled to the network 602 for communication purposes. Such end user computer 608 may include a desktop computer, lap-top computer, and/or any other type of logic. Still yet, various other devices may be coupled to the network 602 including a personal digital assistant (PDA) device 610, a mobile phone device 606, a television 604, etc.

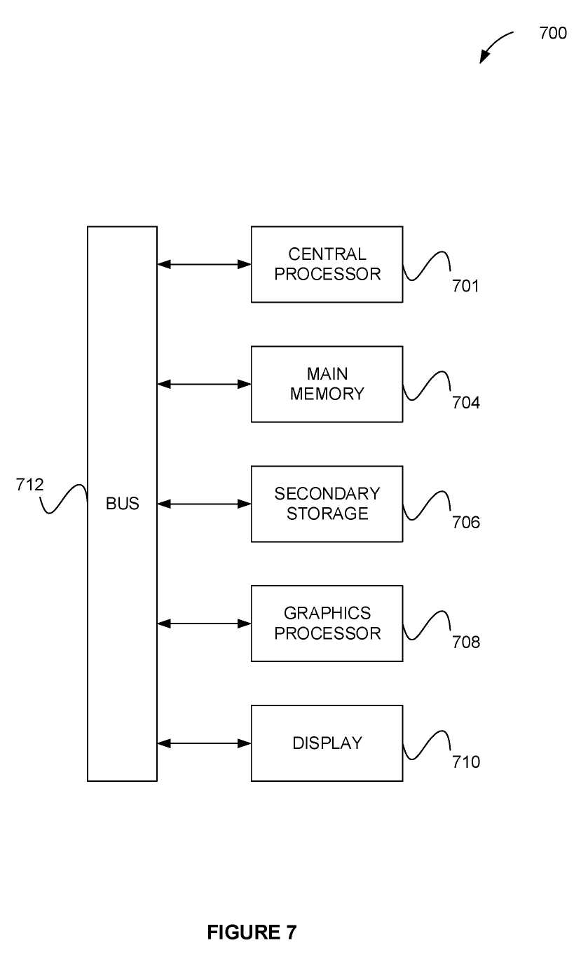

FIG. 7 illustrates an exemplary system 700, in accordance with one embodiment. As an option, the system 700 may be implemented in the context of any of the devices of the network architecture 600 of FIG. 6. However, it is to be appreciated that the system 700 may be implemented in any desired environment.

As shown, a system 700 is provided including at least one central processor 702 which is connected to a bus 712. The system 700 also includes main memory 704 [e.g., hard disk drive, solid state drive, random access memory (RAM), etc.]. The system 700 also includes a graphics processor 708 and a display 710.

The system 700 may also include a secondary storage 706. The secondary storage 706 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 704, the secondary storage 706, and/or any other memory, for that matter. Such computer programs, when executed, enable the system 700 to perform various functions (as set forth above, for example). Memory 704, secondary storage 706 and/or any other storage are possible examples of non-transitory computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A computer readable media comprising computer executable instructions stored on a non-transitory computer readable medium that when executed by one or more processors prompt the one or more processors to:
classify one or more test data points as an anomaly, utilizing a one-class support vector machine (OCSVM);
in connection with each of the one or more test data points classified as an anomaly, determine a density of a plurality of known data points that are each known to not be an anomaly; and
reclassify at least one of the one or more test data points as not being an anomaly, based on the determination to reduce a number of false positives.

2. The computer readable media of claim 1, wherein the computer instructions prompt the one or more processors to classify the one or more test data points as an anomaly, by: grouping a plurality of the test data points into a plurality of groups based on one or more parameters, and identifying at least one frontier for each group of the plurality of the test data points.

3. The computer readable media of claim 2, wherein the computer instructions prompt the one or more processors to classify the one or more test data points as an anomaly, by further: determining whether the one or more test data points are outside a corresponding frontier.

4. The computer readable media of claim 3, wherein the computer instructions prompt the one or more processors to classify the one or more test data points as an anomaly, by further: classifying the one or more test data points as an anomaly if the one or more test data points are outside the corresponding frontier.

5. The computer readable media of claim 1, wherein the computer instructions prompt the one or more processors to classify the one or more test data points as an anomaly, utilizing a K-means clustering algorithm.

6. The computer readable media of claim 1, wherein the computer instructions prompt the one or more processors to reclassify the at least one test data point as not being an anomaly, if the density determined in connection with the at least one test data point exceeds a configurable threshold.

7. The computer readable media of claim 1, wherein the one or more test data points include a plurality of the test data points.

8. The computer readable media of claim 7, wherein the computer instructions prompt the one or more processors to determine the density for each of the plurality of the test data points.

9. The computer readable media of claim 8, wherein the computer instructions prompt the one or more processors to generate density information corresponding with each of the plurality of the test data points.

10. The computer readable media of claim 9, wherein the computer instructions prompt the one or more processors to rank the plurality of the test data points, based on the density information.

11. The computer readable media of claim 10, wherein the computer instructions prompt the one or more processors to allocate resources, based on the ranking.

12. The computer readable media of claim 1, wherein the one or more test data points reflect security event occurrences.

13. A method, comprising:
classifying one or more test data points as an anomaly;
in connection with each of the one or more test data points classified as an anomaly, determining, utilizing at least one processor, a density of a plurality of known data points that are each known to not be an anomaly; and
reclassifying, utilizing the at least one processor, at least one of the one or more test data points as not being an anomaly, based on the determination, for outputting a result thereof via at least one output device in communication with the at least one processor to reduce a number of false positives.

14. The method claim 13, wherein the at least one test data point is reclassified as not being an anomaly, if the density determined in connection with the at least one test data point exceeds a configurable threshold.

15. The method claim 13, wherein the determination of the density is performed for each of the plurality of the test data points, and further comprising: ranking the plurality of the test data points, based on density information corresponding with each of the plurality of the test data points.

16. The method of claim 15, and further comprising: allocating resources, based on the ranking.

17. An apparatus, comprising:
an interface configured to receive one or more test data points that are each classified as an anomaly;
a memory including computer executable instructions; and
at least one processor in communication with the interface and the memory, the at least one processor, in response to an execution of the computer executable instructions, being prompted to:
identify one or more test data points as an anomaly;
in connection with one or more test data points that are each classified as an anomaly, determine a density of a plurality of known data points that are each known to not be an anomaly; and
reclassify at least one of the one or more test data points as not being an anomaly, based on the determination to reduce a number of false positives.

18. The apparatus of claim 17, wherein the apparatus is configured such that the one or more test data points include a plurality of the test data points, the determination of the density is performed for each of the plurality of the test data points, and the determination of the density results in density information corresponding with each of the plurality of the test data points.

19. The apparatus of claim 18, wherein the apparatus is configured to rank the plurality of the test data points, based on the density information.

20. The apparatus of claim 19, wherein the apparatus is configured to allocate resources, based on the ranking.

21. The apparatus of claim 20, wherein the apparatus is configured such that the at least one test data point is reclassified as not being an anomaly, if the density determined in connection with the at least one test data point exceeds a configurable threshold.
